(19) United States
(12) Patent Application Publication
(10) Pub. No.: US 2025/0335581 A1
(43) Pub. Date: Oct. 30, 2025

(54) UNDESIRED OPERATION IDENTIFICATION FROM LOG ENTRY MATCHING ON A DIRECTED ACYCLIC GRAPH

(71) Applicant: Dell Products L.P., Round Rock, TX (US)

(72) Inventors: VINAY SAWAL, Fremont, CA (US); PRASHANT ANANT PARANJAPE, Bangalore (IN); MANOHAR`BABU BARLA, Bangalore (IN); VINDHYA GANGARAJU, Davangere (IN)

(21) Appl. No.: 18/647,306

(22) Filed: Apr. 26, 2024

(51) Int. Cl. G06F 21/55

(52) U.S. Cl. CPC G06F 21/554; G06F 2221/034

(57) ABSTRACT

Methods and systems for managing operation of a deployment comprising data processing systems are disclosed. The operation may be managed by identifying an undesired operation in a data processing system. The undesired operation may be identified by obtaining the offending signature on a directed acyclic graph. The offending signature may be obtained by matching new log entries from a data processing system to a portion of log entries on the directed acyclic graph that are associated with the offending signature. From the log entries, problem contexts and correlation scores may be obtained. The problem contexts, the correlation scores and the offending signature may be used to find the root cause of the undesired operation.

### FIELD

Embodiments disclosed herein relate generally to managing operation of a data processing systems. More particularly, embodiments disclosed herein relate to managing data processing systems using log data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIG. 2D shows a diagram illustrating content of a data structure in accordance with an embodiment.

FIGS. 3A-3B show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment comprising data processing systems. The operation may be managed by improving a likelihood of provisioning of computer implemented services on a data processing system. The improvement of the likelihood of the computer implemented services may require an identification process to be performed.

During the identification process, an undesired operation in the data processing system may be identified. To identify the undesired operation, a search may be performed to match new log entries to a portion of log entries on a directed acyclic graph (DAG). After the new log entries have been matched to the portion of the log entries, the log entries may be traced on the DAG to obtain the offending signature. As the offending signature may be associated with the undesired operation, the undesired operation may be identified by obtaining the offending signature.

Once the undesired operation has been identified by obtaining the offending signature, problem contexts and correlation scores may be obtained. The problem contexts and the correlation scores may be obtained by performing a search in the log entries around the offending signature on the DAG. Using the offending signature, the problem contexts, and the correlation scores, a root cause analysis may be performed to determine the root cause of the undesired operation. Once the root cause is determined, an action set may be developed and implemented to improve the likelihood of the provisioning of the computer implemented services on the data processing system.

In an embodiment, a method for managing operation of a deployment comprising data processing systems is disclosed. The method may include (i) obtaining a portion of log entries from a data processing system of the data processing systems; (ii) making a first determination, based on matching the portion of the log entries to a portion of a directed acyclic graph, regarding whether the data processing system is likely to or has exhibited undesired operation, the directed acyclic graph indicating relationships between offending signatures associated with different types of undesired operation and log entry patterns, and the log entry patterns being problem contexts for the different types of undesired operation of the data processing system; (iii) in a first instance of the first determination where the data processing system is likely to or has exhibited undesired operation: (a) identifying, based on the portion of the log entries, a problem context of the problem contexts; (b) identifying, based on the problem context, a root cause of the undesired operation; (c) identifying, based on the root cause, an action set to remediate the root cause of the undesired operation; and (d) performing the action set to manage an impact of the root cause to improve the likelihood of continued provisioning of computer implemented services by the data processing system.

Making the first determination may include (i) obtaining a new log entry pattern from the portion of the log entries; (ii) analyzing a first log entry pattern of the log entry patterns with respect to the new log entry pattern; (iii) in a first of the analyzing where the first log entry pattern is found to effectively match the new log entry pattern: concluding that the data processing system will exhibit or has exhibited a type of undesired operation associated with an offending signature of the offending signatures that is associated with the first log entry pattern; and (iv) in a second instance of the analyzing where the first log entry pattern is found to not effectively match the new log entry pattern: proceeding to iteratively analyze the new log entry with respect to other log entry patterns of the log entry patterns to attempt to identify the effective match between the new log entry pattern and any of the other log entry patterns.

Identifying the problem context of the problem contexts includes (i) identifying a path of nodes on the directed acyclic graph, the full path of the nodes having a set of nodes, the set of the nodes being assigned log entries, the log entries matching the first log entry pattern; and (ii) obtaining correlation scores from the path of the nodes that are associated with the offending signature on the path of the nodes.

The directed acyclic graph may include nodes and edges between nodes, the edges are defined based on a chronology ascribed to the nodes, and a node of the nodes being ascribed a log entry and a correlation score.

A correlation score may be assigned to each node in the sets of the nodes in the directed acyclic graph and gives a measure of association between the log entry and the undesired operation.

Managing of the operation of the deployment comprising the data processing systems may further include (i) generating data minimized log entries with standardized formatting; and (ii) establishing standardized time for each of the data minimized log entries.

Generating the data minimized log entries may include (i) obtaining a hash signature for a log entry of the portion of the log entries; (ii) assigning the hash signature to the log entry of the portion of the log entries; and (iii) organizing contents of the portion of the log entries to obtain the data minimized log entries.

Establishing the standardized time may include (i) obtaining a timestamp for the log entry of the portion of the data minimized log entries; (ii) assigning the timestamp to the log entry of the portion of the data minimized log entries; and (iii) obtaining, using the portion of the data minimized log entries, a first log entry dataset that has the portion of the data minimized log entries sorted in chronological order.

Managing of the operation of the deployment comprising the data processing systems may further include, prior to obtaining the portion of log entries from the data processing system: (i) obtaining the first log entry dataset; (ii) obtaining the offending signatures from the first log entry dataset; (iii) obtaining problem contexts from the first log entry dataset; (iv) performing, using the first log entry dataset, a correlation analysis between the offending signatures and problem contexts to assign correlation scores to each log entry of the problem contexts; and (v) obtaining, using the offending signatures, the problem contexts, and the correlation scores, the directed acyclic graph.

A second instance of the first determination where the data processing system is not likely to or has not exhibited undesired operation may include continuing the provisioning of the computer implemented services by the data processing system.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

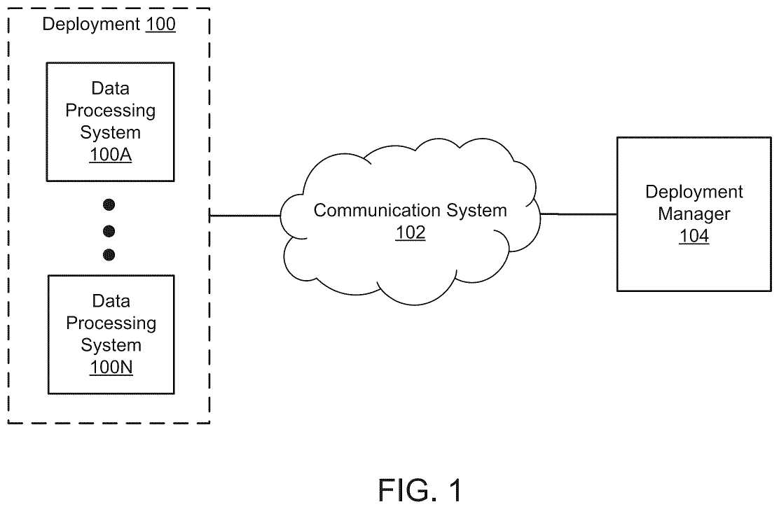

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, data processing systems of the system may include various hardware and software components. To provide any of the above services, the hardware and/or software components may need to operate in predetermined manners. If the hardware and/or software components do not operate in the predetermined manners, then the computer implemented services may not be able to be provided and/or may be provided in a less desirable manner.

In general, embodiments disclosed here relate to systems and methods for managing operation of data processing systems. The operation may be managed by improving a likelihood that the data processing systems are able to provide providing computer implemented services. To improve the likelihood, logs generated by data processing systems may be scanned to identify (i) undesired operations that have already occurred, and (ii) undesired operations that are likely to occur.

The logs may include information regarding the operation of the data processing systems. The logs may be scanned and compared to known relationships between log entry patterns and undesired operation of data processing systems. The relationships may be stored in directed acyclic graphs (DAGs).

The directed acyclic graphs may be based on historic information (e.g., logs of the operation of data processing systems that have suffered undesired operation). For example, logs from data processing systems that have suffered undesired operations in the past may be analyzed to identify patterns of log entries leading up to and/or following occurrences of undesired operations. The log entries prior to and/or following an occurrence of an undesired operation may be referred to as a “problem context”. A log entry that indicates an occurrence of an undesired operation may be referred to as having or displaying an “offending signature”.

The problem contexts from similar undesired operations suffered by any number of data processing systems may be aggregated, analyzed, and used to create a DAG. Any number of DAGs may be established for any number of different types of undesired operation. Each DAG may include nodes that are labeled with log entries from problem contexts for the undesired operation, and edges between the nodes that are based on the chronology of the log entries for which the nodes are labeled.

When creating the DAGs, the level of correlation between log entries and occurrences of undesired operation may be calculated. The nodes of the DAGs corresponding to the log entries may be annotated or otherwise associated with these levels of correlation.

Using the problem contexts and the correlation scores, root cause analysis for a given undesired operation may be performed. During the root cause analysis, the root cause of the undesired operation by the data processing system may be determined. For example, the problem context, correlation levels, etc. may be analyzed to ascertain causes for the undesired operation.

Once the root cause has been determined, an action set may be identified. The action set may be identified to address the root cause of the undesired operation. By addressing the root cause, a likelihood of providing computer implemented services may be improved by either preventing the undesired operation from occurring or resolving an existing occurrence of the undesired operation. The action set may be established manually (e.g., defined by a subject matter expert), semi-automated manner (e.g., a computer agent may suggest actions which may be reviewed and selectively approved by a subject matter expert), and/or in an automated manner (e.g., entirely selected by the agent). Once selected, the action set may be performed.

To provide the above noted functionality, the system may include deployment 100 and deployment manager 104. Each of these components is discussed below.

Deployment 100 may include any number of data processing systems 100A-100N. Data processing systems 100A-100N may include hardware and software that operate in a predefined manner to provide desired computer implemented services. The operation of the hardware and software may be interrupted by an undesired operation. The undesired operation may prevent desired computer implemented services from being provided by data processing systems 100A-100N.

Deployment manager 104 may manage the operation of deployment 100. To do so, deployment manager 104 may scan logs generated by data processing systems 100A-100N to identify current and/or future occurrences of undesired operation. The scan may be performed, for example, using DAGs that are based on historic operation of such systems.

When an undesired operation is identified, deployment manager 104 may facilitate performance of root cause analysis for the undesired operation, and remediation. By doing so, data processing systems 100A-100N may be less likely to exhibit undesired operation.

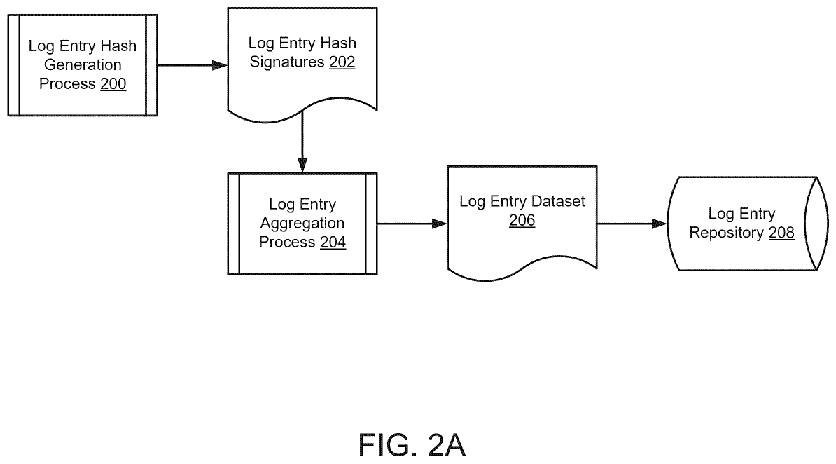

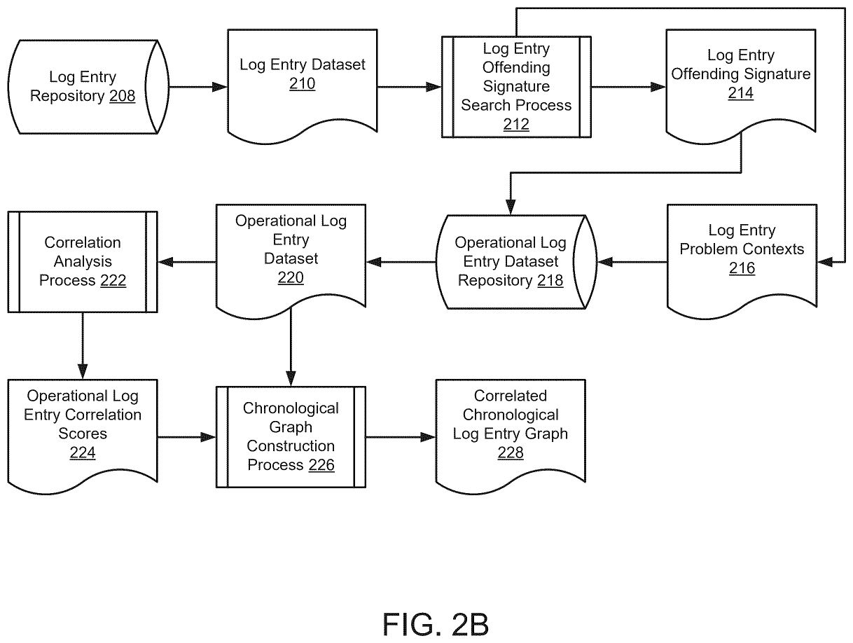

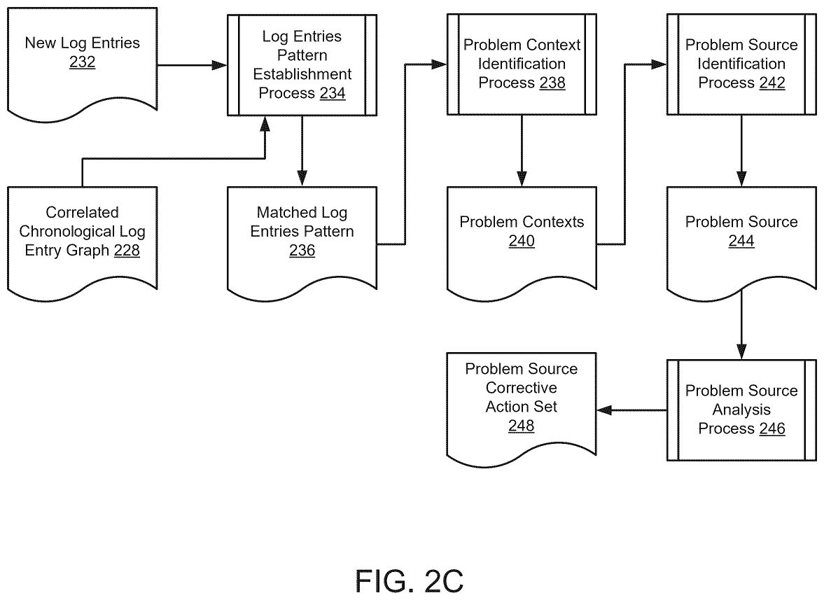

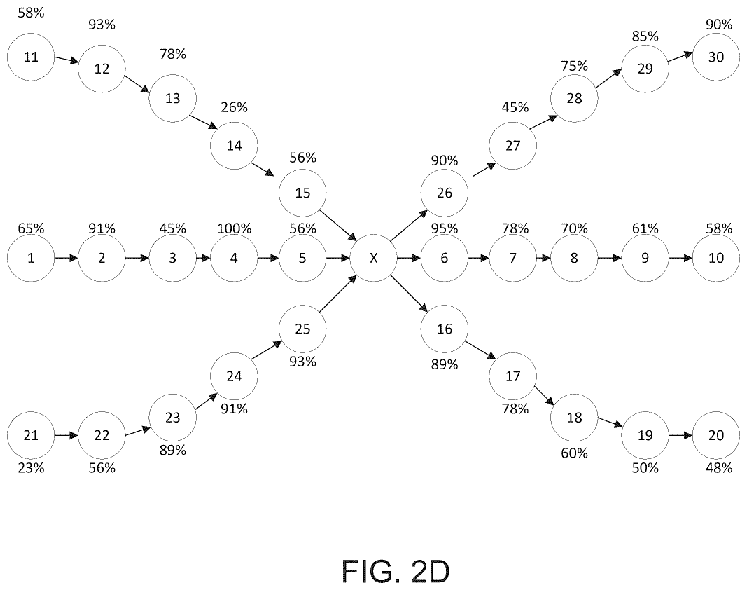

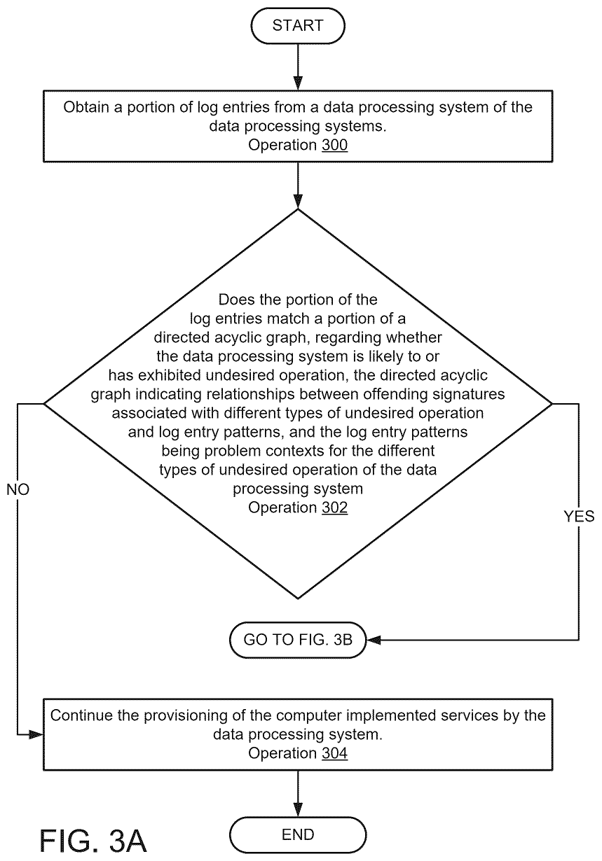

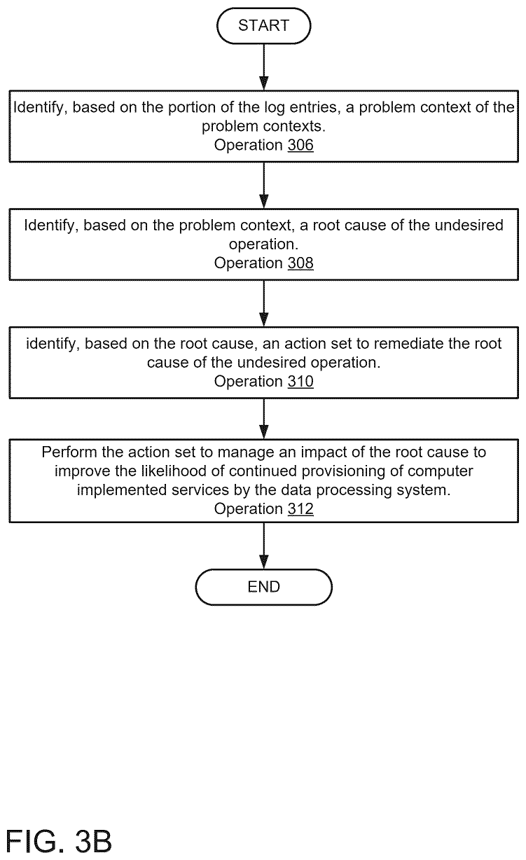

While providing their functionality, any of deployment 100 and deployment manager 104 may perform all, or a portion, of the flows and methods shown in FIGS. 2A-3B.

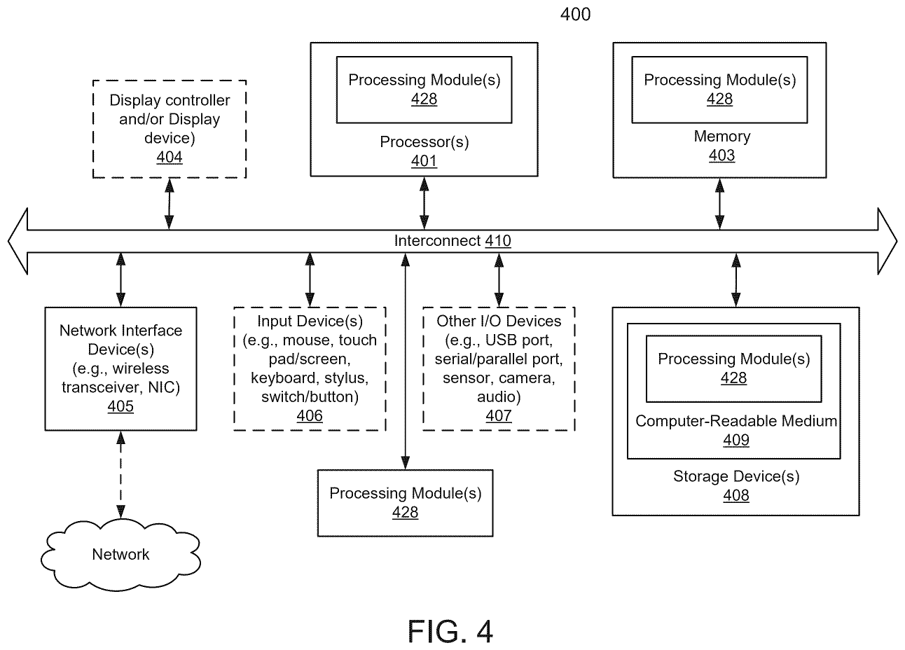

Any of (and/or components thereof) deployment 100 and deployment manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 202, 206, etc.) is used to represent data structures, a second set of shapes (e.g., 200, 204, etc.) is used to represent processes performed using and/or that generate data, and a third set of shapes (e.g., 208, etc.) is used to represent large scale data structures such as databases.

Turning to FIG. 2A, a first data flow diagram in accordance with an embodiment is shown. The first data flow diagram may illustrate data used in and data processing performed in storing log entry datasets into a repository.

To store log entry datasets, log entry hash generation process 200 may be performed. During log entry hash generation process 200, log entries may be obtained from a data processing system. The log entries may be obtained by receiving the log entries from the data processing system.

As log entries are obtained, log entry hash signatures 202 may be generated using a hash algorithm. The log entry hash signatures 202 may improve an efficiency of search queries for log entries stored in log entry repository 208. For example, the hash may be used as a basis for search rather than string-based searching for the log entry of the log entries.

Once log entry hash signatures 202 are obtained, log entry aggregation process 204 may be performed. During log entry aggregation process, the log entries may be modified to standardize the content of the log entries. For example, a format of timestamps in the log entries may be modified (for example, to epoch time in milliseconds) to provide for standardized basis comparison in search queries of the log entries. In addition, a label of keys and/or datum in values may be added, modified, and/or removed to reorder and/or restructure log entries. The reordering and/or restructuring of the log entries may be done to simplify storage and/or analysis of the log entries.

After the reordering and/or the restructuring, log entry dataset 206 may be generated. Log entry dataset 206 may include the modified log entries and corresponding hashes from log entry hash signatures 202. The log entries in log entry dataset 206 may be sorted in chronological order to aid in generating a chronology for problem contexts within the log entries. Once obtained, log entry dataset 206 may be stored in log entry repository 208.

Turning to FIG. 2B, a second data flow diagram in accordance with an embodiment is shown. The second data flow diagram may illustrate data used in and data processing performed in generating a correlated chronological log entry graph.

To generate the correlated chronological log entry graph, log entry offending signature search process 212 may be performed. During log entry offending signature search process 212, log entry dataset 210 may be extracted from log entry repository 208. After extracting log entry dataset 210, a search for a log entry with an offending signature may be performed. The search may be performed by searching for a hash signature in log entry dataset 210 associated with the offending signature.

When the log entry of log entry dataset 210 is found with the offending signature, the log entry may be separated and labeled as log entry offending signature 214. Log entries with problem contexts may remain in log entry dataset 210. The log entries with the problem contexts may have timestamps for within a time period before and after log entry offending signature 214. The log entries with the problem contexts may be labeled as log entry problem contexts 216. Both log entry offending signature 214 and log entry problem contexts 216 may be stored in operational log entry dataset repository 218. Over time, log entry offending signature search process 214 may be iterated to store more log entry datasets in operational log entry dataset repository 218.

To generate the correlated chronological log entry graph, operational log entry dataset 220 may be extracted from operational log entry dataset repository 218. Operational log entry dataset 220 may include log entry offending signature 214 and log entry problem contexts 216. Using operational log entry dataset 220, correlation analysis process 222 may be performed.

During correlation analysis process 222, a correlation score between log entry offending signature 214 and a problem context of log entry problem contexts 216 may be computed. The correlation score may be computed by generating a measure of association between log entry offending signature 214 and the problem context of log entry problem contexts 216. The measure of association may be generated by employing statistical methods in a chronological-based analysis. The statistical methods may include how a likelihood and frequency of the problem context appearing before and/or after the offending signature. Using the statistical methods, operational log entry correlation scores 224 may be generated.

Using operational log entry correlation scores 224 and operational log entry dataset 220, chronological graph construction process 226 may be performed. During chronological graph construction process 226, a graph that illustrates a chronology of log entry offending signature 214 and log entry problem contexts 216 with operational log entry correlation scores 224 may be generated. A DAG may be an example of the correlated chronological log entry graph 228 generated by chronological graph construction process 226.

The DAG may include nodes and edges between nodes. The edges may be defined based on a chronology ascribed to the nodes. Further, a node of the nodes may be ascribed a log entry and a correlation score. The log entry may include a problem context. The problem context may describe operation of the data processing system that is related to an undesired operation, referenced by log entry offending signature 214, by the data processing system. The correlation score may be a measure of association of the log entry to the offending signature. The offending signature may be ascribed to a central node of the DAG and one or more sets of the nodes with the edges between the nodes may provide a path to the offending signature.

The generation of the correlated chronological log entry graph may begin with log entry offending signature search process 212. During log entry offending signature search process 212, log entry dataset 210 may be extracted from log entry repository 208. Then, a search may take place for log entry offending signature 214 within log entry dataset 210. Once log entry offending signature 214 is found, log entry problem context 216, which have timestamps within some time period before and after log entry offending signature 214, may be separated from log entry dataset 210. Log entry offending signature 214 and log entry problem context 216 may be stored in operational log entry dataset repository 218.

Operational log entry dataset 220 may be extracted from operational log entry dataset repository 218. After the extraction, correlation analysis process 222 may be performed with operational log entry dataset 220, which includes log entry offending signature 214 and log entry problem contexts 216. During correlation analysis process 222, operational log entry correlation scores 224 may be generated. Operational log entry correlation scores 224 may include correlation scores for log entry offending signature 214 and a problem context in log entry problem contexts 216.

Using operational log entry correlation scores 224 and operational log entry dataset 220, chronological graph construction process 226 may be performed. During chronological graph construction process 226, correlated chronological log entry graph 228, which includes a DAG, may be generated.

Turning to FIG. 2C, a third data flow diagram in accordance with an embodiment is shown. The third data flow diagram may illustrate data used in and data processing performed in generating a corrective action set for an undesired operation of a data processing system.

To generate the corrective action set, log entries pattern establishment process 234 may be performed. During log entries pattern establishment process 234, new log entries 232 may be obtained. New log entries 232 may be obtained by receiving them from the data processing system.

Using new log entries 232, an attempt may be made to match new log entries 232 to log entries of nodes of correlated chronological log entries graph 228. If the log entries of the nodes of correlated chronological log entries graph 228 do not match new log entries 232, then log entries pattern establishment process 234 may be performed iteratively to match new log entries 232 to the log entries of other nodes of correlated chronological log entries graph 228.

Otherwise, if the log entries of the nodes of correlated chronological log entries graph 228 match new log entries 232, then matched log entries pattern 236 may be determined. Matched log entries pattern 236 may include the log entries in new log entries 232. Also, a path along edges of the nodes of correlated chronological log entries graph 228 may be traced to a node that includes an offending signature. As the offending signature may be identified, a conclusion may be made using matched log entries pattern 236 that an undesired operation may occur in the data processing system.

After determining matched log entries pattern 236 and concluding that an undesired operation has or will occur, problem context identification process 238 may be performed. During problem context identification process 238, problem context 240 for the offending signature may be obtained. The problem contexts may be obtained by identifying log entries from nodes that have timestamps earlier and later than the offending signature. Additionally, problem contexts 240 may include correlation scores for the problem contexts. The correlation scores may be obtained from the nodes that have log entries with timestamps earlier and later than the log entry with the offending signature.

Using problem contexts 240, problem source identification process 242 may be performed. During problem source identification process 242, a root cause analysis may be performed to find the root cause of an undesired operation associated with the offending signature. The root cause analysis may be performed by using a keyword recognition process in the problem contexts and associations, using the correlation scores, between the keywords and hardware and software components in the data processing system. For example, the keywords for the software components may appear in the problem contexts with high correlation scores. The software components may then be considered as a source of the root cause of the undesired operation. Therefore, the root cause analysis may consider the software components for further analysis of the root cause of the undesired operation.

During problem source identification process 242, problem contexts and correlation scores may be used to search the hardware and software components for problem source 244. Once problem source 244 is determined, problem source analysis process 246 may be performed. During problem source analysis process 246, problem source corrective action set 248 may be determined to address the root cause of the undesired operation. Problem source corrective action set 248 may be identified by defining, by an administrator and/or remediative software, procedures to perform on the data processing system to address the root cause.

To generate the corrective action set, new log entries 232 may be obtained from a data processing system. New log entries 232 may be matched to a portion of correlated chronological log entry graph 228. From the matching, matched log entries pattern 236 may be obtained. Matched log entries pattern 236 may be used to obtain an offending signature. The offending signature may indicate a current undesired operation and/or a future undesired operation. During problem context identification process 238, matched log entries pattern 236 may be used to identify problem contexts 240. Problem contexts 240 may include problem contexts associated with the offending signature and correlation scores associated with the problem contexts.

Problem contexts 240 may be ingested by problem source identification process 242. During problem source identification process 242, a root cause analysis may be performed to determine problem source 244. From problem source 244, a root cause of the current undesired operation and/or a future undesired operation may be ingested by problem source analysis process 246. During problem source analysis process 246, problem source corrective action set 248 may be obtained. Problem source corrective action set 248 may be a set of procedures that are identified and performed by an administrator and/or remediative software to address an undesired operation associated with the offending signature.

Turning to FIG. 2D, a fourth diagram in accordance with an embodiment is shown. The fourth diagram may illustrate an example of a correlated chronological log entry graph in accordance with an embodiment.

A correlated chronological log entry graph may include nodes and edges between nodes. The edges may be defined based on a chronology ascribed to the nodes. An example of a correlated chronological log entry graph is a DAG and is shown in FIG. 2D. Each node may include a reference number (for example, 1, 2, 3, etc.) and a correlation score. Also, each node may also include a log entry, which is not shown in FIG. 2D. The log entry may include a problem context, a timestamp, and other context about the log entry.

The central node may include in the log entry an offending signature rather than a problem context. The offending signature may be a message indicating an undesired operation in a data processing system. Further, the central node may be labeled with an “X” rather than a reference number.

The central node may be associated with a series of nodes along the DAG. For example, since the DAG represents a chronological relationship from left to right between the nodes, the nodes with reference labels [1, 2, 3, 4, 5, X, 6, 7, 8, 9, 10] may be associated with a first series of log entries from a data processing system. Similarly, the nodes with reference labels [11, 12, 13, 14, 15, X, 16, 17, 18, 19, 20] may be associated with a second series of the log entries from the data processing system. Finally, the nodes with reference labels [21, 22, 23, 24, 25, X, 26, 27, 28, 29, 30] may be associated with a third series of the log entries from the data processing system.

To use the DAG, new log entries 232 may be received from the data processing system. New log entries 232 may be used in log entries pattern establishment process 234. During log entries pattern establishment process 234, the log entries from new log entries 232 may be compared to the log entries included within any portion of the three series of nodes in FIG. 2D. When a portion of the log entries is found to match, matched log entries pattern 236 may be any portion of the log entries included with any of the three series of the nodes in FIG. 2D. Once, matched log entries pattern 236 is determined, the series of the nodes may be traced along the edges in a series of the nodes to obtain the problem contexts, the correlation scores, and offending signature.

For example, consider when new log entries 232 includes a first set of log entries. Matching of the log entries may be determined in log entries pattern establishment process 234. During log entries pattern establishment process 234, the first set of the log entries may be found to match a second set of the log entries from nodes 1, 2, and 3. By matching the first set of the log entries to the second set of the log entries, matched log entries pattern 236 may be identified.

To obtain the offending signature associated with matched log entries pattern 236, the series of the nodes that includes matched log entries pattern 236 may be traced. Since matched log entries pattern 236 includes the log entries from nodes 1, 2, and 3, the series of the nodes with the reference labels [1, 2-5, X, 6, 7-10] may be traced. On tracing the series of the nodes, the node with the reference label “X” may be identified. The offending signature may be obtained from the node with the reference label “X”. Also, from all nodes in the series of the nodes, except for the node with the reference label “X”, the log entries that include problem contexts and the correlation scores may be obtained.

A correlated chronological log entry graph is illustrated in FIG. 2D. A DAG may be an example of the correlated chronological log entry graph. Using the DAG and a first set of log entries provided by the data processing system, the first set of log entries may be matched to a second set of the log entries within a portion of the nodes in the DAG. After the first set of the log entries is matched to the second set of the log entries, a series of the series of the nodes on the DAG may be identified. Once the series of a set of series of the nodes on the DAG is identified, the offending signature may be obtained. Further, the problem contexts and the correlation scores in the series of the nodes may be obtained.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage power consumption by data processing systems. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing operation of a deployment comprising data processing systems in accordance with an embodiment is shown. The method may be performed, for example, by any of the components of the system of FIG. 1, and/or other components not shown therein.

At operation 300, a portion of log entries may be obtained from a data processing system of the data processing systems. The portion of the log entries may be obtained by receiving the log entries from the data processing system.

At operation 302, a determination may be made whether the portion of the log entries match to a portion of a directed acyclic graph, regarding whether the data processing system is likely to or has exhibited undesired operation, the directed acyclic graph indicating relationships between offending signatures associated with different types of undesired operation and log entry patterns, and the log entry patterns being problem contexts for the different types of undesired operation of the data processing system. The determination may be made by (i) obtaining a new log entry pattern from the portion of the log entries and (ii) analyzing a first log entry pattern of the log entry patterns with respect to the new log entry pattern;

The new log entry pattern may be obtained by selecting the log entry pattern from the portion of the log entry patterns. The first log entry pattern of the log entry patterns may be analyzed with respect to the new log entry pattern by comparing the first log entry pattern to the new log entry pattern.

If the first log entry pattern is found to effectively match the new log entry pattern, then the conclusion may be reached that that the data processing system will exhibit or has exhibited a type of undesired operation associated with an offending signature of the offending signatures that is associated with the first log entry pattern. The conclusion may be reached by tracing log entry patterns from the first log entry pattern to the offending signature along the directed acyclic graph.

Otherwise, if the first log entry pattern is not found to effectively match the new log entry pattern, then the new log entry pattern may be iteratively analyzed with respect to other log entry patterns of the log entry patterns to attempt to identify the effective match between the new log entry pattern and any of the other log entry patterns. The new log entry pattern may be iteratively analyzed by comparing the first log entry pattern to other log entry patterns on the directed acyclic graph.

If the portion of the log entries matches the portion of the directed acyclic graph, then the method may continue at operation 306. Otherwise, if the portion of the log entries does not match the portion of the directed acyclic graph, then the method may continue at operation 304.

From operation 302, at operation 304, the provisioning of the computer implemented services by the data processing system may be continued. The provisioning may be continued by performing, by the data processing system, hardware and software operations in a predefined manner. The method may end following operation 304.

From operation 302, turning to FIG. 3B, at operation 306, a problem context of the problem contexts may be identified based on the portion of the log entries. The problem context may be identified by (i) identifying a path of nodes on the directed acyclic graph, the full path of the nodes having a set of nodes, the set of the nodes being assigned log entries, the log entries matching the first log entry pattern; and (ii) obtaining correlation scores from the path of the nodes that are associated with the offending signature on the path of the nodes.

The path of the nodes on the directed acyclic graph may be identified by tracing the path of the nodes using edges between the nodes. The correlation scores may be obtained from the path of the nodes by identifying the correlation scores assigned to the nodes along the path of the nodes.

At operation 308, a root cause of the undesired operation may be identified, based on the problem context. The root cause may be identified by performing a root cause analysis that ingests the problem context to determine the root cause of the undesired operation.

At operation 310, an action set to remediate the root cause of the undesired operation may be identified, based on the root cause. The action set may be identified by determining actions to perform on the data processing system. The actions may address the root cause of the undesired operation by the data processing system and/or manage an impact of the root cause of the undesired operation.

At operation 312, the action set may be performed to manage the impact of the root cause to improve the likelihood of continued provisioning of computer implemented services by the data processing system. The action set may be performed by (i) sending instructions for the action set to the data processing system and (ii) implementing the instructions on the data processing system.

The method may end following operation 312.

Thus, via the method shown in FIGS. 3A-3B, embodiments herein may likely improve a likelihood that data processing systems may provide computer implemented services. By improving the likelihood that the data processing systems provide the computer implemented services, the data processing systems may be more likely to provide desirable computer implemented services by, for example, monitoring log entries for errors in operation, having an improved security posture, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment comprising data processing systems, the method comprising:
obtaining a portion of log entries from a data processing system of the data processing systems;
making a first determination, based on matching the portion of the log entries to a portion of a directed acyclic graph, regarding whether the data processing system is likely to or has exhibited undesired operation, the directed acyclic graph indicating relationships between offending signatures associated with different types of undesired operation and log entry patterns, and the log entry patterns being problem contexts for the different types of undesired operation of the data processing system;
in a first instance of the first determination where the data processing system is likely to or has exhibited undesired operation:
identifying, based on the portion of the log entries, a problem context of the problem contexts;
identifying, based on the problem context, a root cause of the undesired operation;
identifying, based on the root cause, an action set to remediate the root cause of the undesired operation; and
performing the action set to manage an impact of the root cause to improve a likelihood of continued provisioning of computer implemented services by the data processing system.

2. The method of claim 1, wherein making the first determination comprises:
obtaining a new log entry pattern from the portion of the log entries;
analyzing a first log entry pattern of the log entry patterns with respect to the new log entry pattern;
in a first of the analyzing where the first log entry pattern is found to effectively match the new log entry pattern:
concluding that the data processing system will exhibit or has exhibited a type of undesired operation associated with an offending signature of the offending signatures that is associated with the first log entry pattern;
in a second instance of the analyzing where the first log entry pattern is found to not effectively match the new log entry pattern:
proceeding to iteratively analyze the new log entry with respect to other log entry patterns of the log entry patterns to attempt to identify the effective match between the new log entry pattern and any of the other log entry patterns.

3. The method of claim 2, wherein identifying the problem context of the problem contexts comprises:
identifying a path of nodes on the directed acyclic graph, a full path of the nodes having a set of nodes, the set of the nodes being assigned log entries, the log entries matching the first log entry pattern; and
obtaining correlation scores from the path of the nodes that are associated with the offending signature on the path of the nodes.

4. The method of claim 2, wherein the directed acyclic graph comprises nodes and edges between nodes, the edges are defined based on a chronology ascribed to the nodes, and a node of the nodes being ascribed a log entry and a correlation score.

5. The method of claim 4, wherein a correlation score is assigned to each node in the sets of the nodes in the directed acyclic graph and gives a measure of association between the log entry and the undesired operation.

6. The method of claim 1, further comprising:
generating data minimized log entries with standardized formatting; and
establishing standardized time for each of the data minimized log entries.

7. The method of claim 6, wherein generating the data minimized log entries comprises:
obtaining a hash signature for a log entry of the portion of the log entries;
assigning the hash signature to the log entry of the portion of the log entries; and
organizing contents of the portion of the log entries to obtain the data minimized log entries.

8. The method of claim 6, wherein establishing the standardized time comprises:
obtaining a timestamp for the log entry of the portion of the data minimized log entries;
assigning the timestamp to the log entry of the portion of the data minimized log entries; and
obtaining, using the portion of the data minimized log entries, a first log entry dataset that has the portion of the data minimized log entries sorted in chronological order.

9. The method of claim 6, further comprising:
prior to obtaining the portion of log entries from the data processing system:
obtaining a first log entry dataset;
obtaining the offending signatures from the first log entry dataset;
obtaining problem contexts from the first log entry dataset;
performing, using the first log entry dataset, a correlation analysis between the offending signatures and problem contexts to assign correlation scores to each log entry of the problem contexts; and
obtaining, using the offending signatures, the problem contexts, and the correlation scores, the directed acyclic graph.

10. The method of claim 1, wherein in a second instance of the first determination where the data processing system is not likely to or has not exhibited undesired operation:
continuing the provisioning of the computer implemented services by the data processing system.

11. A non-transitory machine-readable medium having instructions stored therein, which when executed by a processor, cause the processor to perform operations for managing a deployment comprising data processing systems, the operations comprising:
obtaining a portion of log entries from a data processing system of the data processing systems;
making a first determination, based on matching the portion of the log entries to a portion of a directed acyclic graph, regarding whether the data processing system is likely to or has exhibited undesired operation, the directed acyclic graph indicating relationships between offending signatures associated with different types of undesired operation and log entry patterns, and the log entry patterns being problem contexts for the different types of undesired operation of the data processing system;
in a first instance of the first determination where the data processing system is likely to or has exhibited undesired operation:
identifying, based on the portion of the log entries, a problem context of the problem contexts;
identifying, based on the problem context, a root cause of the undesired operation;
identifying, based on the root cause, an action set to remediate the root cause of the undesired operation; and
performing the action set to manage an impact of the root cause to improve a likelihood of continued provisioning of computer implemented services by the data processing system.

12. The non-transitory machine-readable medium of claim 11, wherein making the first determination comprises:
obtaining a new log entry pattern from the portion of the log entries;
analyzing a first log entry pattern of the log entry patterns with respect to the new log entry pattern;
in a first of the analyzing where the first log entry pattern is found to effectively match the new log entry pattern:
concluding that the data processing system will exhibit or has exhibited a type of undesired operation associated with an offending signature of the offending signatures that is associated with the first log entry pattern;
in a second instance of the analyzing where the first log entry pattern is found to not effectively match the new log entry pattern:
proceeding to iteratively analyze the new log entry with respect to other log entry patterns of the log entry patterns to attempt to identify the effective match between the new log entry pattern and any of the other log entry patterns.

13. The non-transitory machine-readable medium of claim 12, wherein identifying the problem context of the problem contexts comprises:
identifying a path of nodes on the directed acyclic graph, a full path of the nodes having a set of nodes, the set of the nodes being assigned log entries, the log entries matching the first log entry pattern; and
obtaining correlation scores from the path of the nodes that are associated with the offending signature on the path of the nodes.

14. The non-transitory machine-readable medium of claim 12, wherein the directed acyclic graph comprises nodes and edges between nodes, the edges are defined based on a chronology ascribed to the nodes, and a node of the nodes being ascribed a log entry and a correlation score.

15. The non-transitory machine-readable medium of claim 14, wherein a correlation score is assigned to each node in the sets of the nodes in the directed acyclic graph and gives a measure of association between the log entry and the undesired operation.

16. A data processing system, comprising:
a processor; and
a memory coupled to the processor to store instructions, which when executed by the processor, cause the processor to perform operations for managing a deployment comprising data processing systems, the operations comprising:
obtaining a portion of log entries from a data processing system of the data processing systems;
making a first determination, based on matching the portion of the log entries to a portion of a directed acyclic graph, regarding whether the data processing system is likely to or has exhibited undesired operation, the directed acyclic graph indicating relationships between offending signatures associated with different types of undesired operation and log entry patterns, and the log entry patterns being problem contexts for the different types of undesired operation of the data processing system;
in a first instance of the first determination where the data processing system is likely to or has exhibited undesired operation:
identifying, based on the portion of the log entries, a problem context of the problem contexts;
identifying, based on the problem context, a root cause of the undesired operation;
identifying, based on the root cause, an action set to remediate the root cause of the undesired operation; and
performing the action set to manage an impact of the root cause to improve a likelihood of continued provisioning of computer implemented services by the data processing system.

17. The data processing system of claim 16, wherein making the first determination comprises:
obtaining a new log entry pattern from the portion of the log entries;
analyzing a first log entry pattern of the log entry patterns with respect to the new log entry pattern;
in a first of the analyzing where the first log entry pattern is found to effectively match the new log entry pattern:
concluding that the data processing system will exhibit or has exhibited a type of undesired operation associated with an offending signature of the offending signatures that is associated with the first log entry pattern;
in a second instance of the analyzing where the first log entry pattern is found to not effectively match the new log entry pattern:
proceeding to iteratively analyze the new log entry with respect to other log entry patterns of the log entry patterns to attempt to identify the effective match between the new log entry pattern and any of the other log entry patterns.

18. The data processing system of claim 17, wherein identifying the problem context of the problem contexts comprises:
identifying a path of nodes on the directed acyclic graph, a full path of the nodes having a set of nodes, the set of the nodes being assigned log entries, the log entries matching the first log entry pattern; and
obtaining correlation scores from the path of the nodes that are associated with the offending signature on the path of the nodes.

19. The data processing system of claim 17, wherein the directed acyclic graph comprises nodes and edges between nodes, the edges are defined based on a chronology ascribed to the nodes, and a node of the nodes being ascribed a log entry and a correlation score.

20. The data processing system of claim 19, wherein a correlation score is assigned to each node in the sets of the nodes in the directed acyclic graph and gives a measure of association between the log entry and the undesired operation.
